(19) United States
(12) Patent Application Publication
(10) Pub. No.: US 2009/0227142 A1
(43) Pub. Date: Sep. 10, 2009

(54) AUDIO CONNECTOR WITH GANGED ARTICULATION NETWORKS

(76) Inventor: Bruce Brisson, Auburn, CA (US)

Correspondence Address: LAW OFFICES OF TIMOTHY BRISSON, 340 GRASS VALLEY HIGHWAY, AUBURN, CA, 95603, US

(21) Appl. No.: 12/271,930

(22) Filed: Nov. 17, 2008

Related U.S. Application Data
(63) Continuation-in-part of application No. 11/619,848, filed on Jan. 4, 2007.
(60) Provisional application No. 60/756,057, filed on Jan. 4, 2006.
(60) Provisional application No. 61/003,256, filed on Nov. 15, 2007.

(51) Int. Cl. H01R 13/66

(52) U.S. Cl. 439/620.01

(57) ABSTRACT

This disclosure provides for articulation networks that result in a wider and flatter articulation range throughout the audio spectrum. Articulation networks are disclosed herein for providing a desirable articulation response profile through a gang of networks that maintain a substantially constant Q throughout the audio spectrum. A constant Q is desirable because the music/speech will not possess non-linear peaks in presence or non-linear shifts of the timbre. The articulation networks may be disposed within a networked connector.

### CROSS REFERENCE TO RELATED APPLICATIONS

This application is a continuation-in-part application of U.S. patent application Ser. No. 11/619,848, filed Jan. 4, 2007, which claims priority to provisional application 60/756,057, filed Jan. 4, 2006. This application also claims priority to provisional application 61/003,256, filed Nov. 15, 2007.

### BACKGROUND

The modern Western Chromatic scale has been around for some time. However, there was much debate initially regarding the “interval”, or space, between neighboring notes.

For example, Pythagoras, Philolaos, Boethius and Zarlino, who were rationalists, justified their systems based on numerical relations (2/1, 3/2, 9/8, 5/4, etc.). Zarlino justifies his system of scenario using only the first six numbers; there were only six planets known at the time.

More complex scenarios, such as the notion of overtones and acoustics comes later, in the XVII century, with Sauveur. Historically, other tone systems were proposed giving rise to other categories of consonances.

For example Archytas, a student of Philolaos, noticed that all the “Pythagorean ratios”, such as 2/1, 3/2, 4/3, and 9/8, are epimore (superparticular [n+1/n]), and built another system based on the superparticular ratios. He also built another system based on the Pythagorean scale that contained four fifths and five fourths, giving more commensurabilities than can be attained from any other eight notes.

Eventually, the modern chromatic scale emerged that divided the space between octaves (a doubling of a note) into twelve intervals. Each note in the chromatic scale is referred to in music theory according to its relative position in the scale, i.e., the note after the root note is the “second”, the next note is the “third” and so on.

In modern music, not all of the twelve available notes are used in every situation. A smaller subset of notes defining a scale is used. For example, the backbone of Western music is formed using the diatonic scale wherein music is composed in major and minor keys—a system codified more than 300 years ago. In this hierarchical scheme, out of the twelve possible tones of the chromatic scale, seven enjoy elevated status. In popular music, the pentatonic scale is prevalent, a scale that uses only five notes.

In particular, the characteristics of the octave and the fifth are highly significant, because these two intervals can be regarded as the origin of the chromatic tone scale. Indeed, as was basically shown by Pythagoras, the entire chromatic scale emerges “automatically” when the criterion is employed that the scale must include both the octave and the fifth interval above and below any tone that previously was determined.

Historically, each interval of the chromatic scale was given a role in keeping with the presence of the church at the time. For example, the first and fifth in a scale are absolute monarchs: without them, there can be no music. The third, fourth and seventh intervals are aristocrats—mighty lords of harmony. Most complex and interesting harmonies are built using these “melody notes”. The second and sixth intervals are more like clergy: influential within their proper sphere. The remaining five tones are music's canaille, the street mob.

Thus, certain intervals of the scale impart more impact or feeling that others.

### BRIEF DESCRIPTION OF THE DRAWINGS

FIG. 1 is a graphical illustration of the articulation response of a typical audio cable.

FIG. 2 is an assembly drawing of a networked connector in accordance with the teachings of this disclosure;

FIG. 3 shows a side view of a PCB assembly in accordance with the teachings of this disclosure;

FIG. 4 is a view of the back side of a PCB assembly in accordance with the teachings of this disclosure;

FIG. 5 shows an exemplary circuit in schematic form in accordance with the teachings of this disclosure;

FIG. 6 shows the front surface of a PCB assembly in accordance with the teachings of this disclosure; and

Referring now to FIG. 7, a cross-sectional assembly diagram of networked connector is shown assembled in accordance with the teachings of this disclosure.

### DETAILED DESCRIPTION

This disclosure provides for compensating for articulation problems in audio cable. Generally speaking, articulation refers to audible qualities that enable us to hear in 3-D. The articulation of an electrical circuit or network follows the shape of the “Q”. The inverse of the “Q” is called the dampening factor.

An audio cable may be modeled as a having a series inductive element formed by the conductors, and a parallel capacitive component formed by the space between the two conductors. Thus, an audio cable forms a network having its own articulation characteristics.

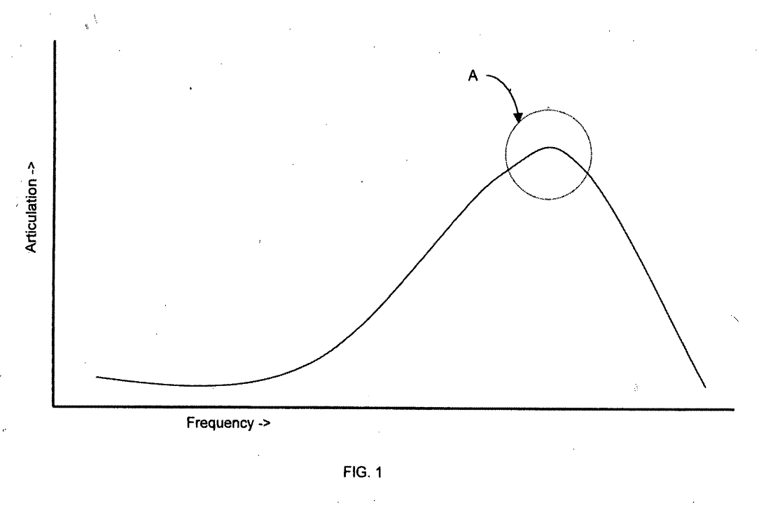

FIG. 1 is a graphical representation of the articulation response of a typical audio cable. Note that the articulation rises with frequency, peaking in a region labeled A. Region A shows that normal audio cable have a narrow articulation range defined by a single random pole that is arbitrarily created by the electrical characteristics of the cable.

The narrow articulation range of the region A is audible to listeners as the articulation affects audible information in the frequency range of the region. A narrow articulation peak can have the effect of unnaturally modifying the timbre and presence of music or speech.

An object of this disclosure is to provide a wider and flatter articulation range throughout the audio spectrum. Such a wide, flat articulation range is desired because it will not change the timbre or presence of the music or speech.

One method disclosed herein for providing a desirable articulation response profile is to provide a gang of networks that maintain a substantially constant Q throughout the audio spectrum. A constant Q is very desirable because the music/speech will not possess non-linear peaks in presence or non-linear shifts of the timbre.

In preferred embodiments, the articulation of a single-pole cable or network is normalized by placing ganged multiple networks at pre-determined intervals. Component values of the circuits are chosen such that the circuit has a desired articulation characteristic at a desired frequency. Multiple circuits may then be provided that are each designed to operate in an individual frequency slot. The articulation circuits may be spaced along the frequency axis at pre-defined intervals. In preferred embodiment, target frequency slots are chosen that correspond to notes or intervals in a musical scale.

The process of articulation normalization begins with choosing a starting or reference frequency. It is contemplated that the natural peak articulation frequency of a cable may be used, such as the peak illustrated in FIG. 1. Alternatively, a desired note may be chosen, such as the lowest note in a particular scale.

Once a reference frequency is determined, target frequency slots are calculated having frequency intervals corresponding to desired intervals of a desired scale. A gang of articulation networks are then provided that populate the desired intervals throughout the audio spectrum. The intervals at which the articulation networks are deployed may be chosen in a wide variety of ways. For example, the constituent members of the network gang may each be spaced at intervals of octaves or fifths throughout the audio spectrum.

Alternatively, the articulation network gang may be placed along a desired music scale such as the pentatonic or diatonic scales. It is contemplated that ratios other than music scales may be used as well, such as Pythagoras or Fibonacci numbers may be used to calculate articulation intervals.

Examples of intervals of a given scale and their respective ratios are given in the following table:

| | frequency |
|---|---|
| Interval | ratio |
| Unison | 1.000000:1 |
| Semitone or minor second | 1.059463:1 |
| Whole tone or major second | 1.122462:1 |
| Minor third | 1.189207:1 |
| Major third | 1.259921:1 |
| Perfect fourth | 1.334840:1 |
| Augmented fourth/Diminished fifth | 1.414214:1 |
| Perfect fifth | 1.498307:1 |
| Minor sixth | 1.587401:1 |
| Major sixth | 1.681793:1 |
| Minor seventh | 1.781797:1 |
| Major seventh | 1.887749:1 |
| Octave | 2.000000:1 |

For example, if a reference frequency of 100 Hz is chosen, articulation networks may be deployed at octaves of 100 Hz, i.e., 200, 400, 800 Hz, etc. Additionally, articulation networks may be placed at fifths, i.e., 150 Hz, 300, 600 Hz, etc.

The articulation networks typically comprise a series RC network placed in parallel with the conductors of the host cable. The values of the articulation network's components are chosen such that the network has a desired Q profile at a desired frequency. In preferred embodiments, the Q is typically less than 1 at the target articulation frequency, and is typically less that the Q of the host cable at the cable's natural articulation point.

Additionally, the Q of the gang as a whole should be relatively constant throughout the audio spectrum. Typically, a cables' articulation peak response is under-damped which may create undesirable ringing along with the presence and timbre issues related above. By adding the articulation networks the articulation response is not only broadened over a much wider range of frequencies but proper dampening is assured.

It is contemplated that the articulation networks may be employed in a variety of applications. For example, the networks may be formed from surface mount components and may of such a size as to be installed in the connectors of various electronic devices. In such embodiments, the components of the networks may be installed internally between the conductors of the connector. Such devices may include the RCA-type connectors typically found in home theater interconnect cables.

Additionally, the networks may be installed in any other two-port connector, such as ¼″ and ⅛″ connectors found in electronics devices.

It is contemplated that the networks may also be installed internal to the device itself. For example, the networks may be installed in the housing of headphones. In further embodiments, the networks may be installed in a coupling adaptor that is installed in-line between a source and destination of an electronic signal.

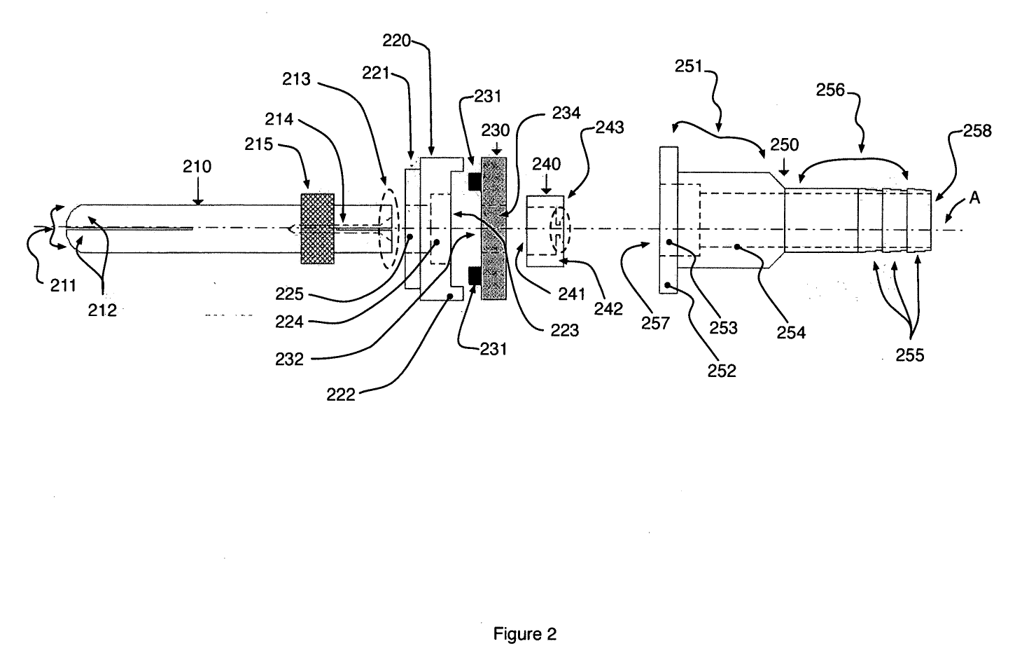

FIG. 2 is an assembly drawing of a networked connector 200 in accordance with the teachings of this disclosure. The exemplary embodiment of FIG. 2 shows the networks of this disclosure being deployed internally to an RCA-type connector, but it is to be understood that the teachings of this disclosure may be employed in other types of connectors as well.

FIG. 2 shows the internal components of the networked connector 200, including, from left to right, a center pin 210, an insulator 220, a printed circuit board (“PCB”) assembly 230, a center guide insulator 240, and a core funnel 250. In an exemplary embodiment, the components of the networked connector 200 are circular in nature and arrange concentrically about an axis A.

The center pin 210 is formed from a conductive material and is adapted to be received by, and make an electrical connection with, a female RCA connector as is know in the art. The center pin 210 is generally cylindrically shaped about axis A and may include a front portion 211 that include a pair of tangs 211 formed therein that are configured to be deformed upon mating with a female connector, thereby maintaining electrical contact with the positive portion of the female receptacle while inserted.

The center pin 210 may also include a rear portion 213 that includes an internal bore 214. The internal bore 214 is preferably includes a conically-shaped portion tapering inwards towards the forward portion 211 that is configured to receive and guide the center conductor of a coaxial cable to which the connector 200 is attached. The length and shape of the bore 214 is preferably shaped to maintain electrical contact with the center conductor. The center pin 210 may also include a retainer ring 215 disposed about the outer circumference on the center pin 210 proximate to the rear portion 213.

The networked connector 200 also includes an insulator 220, preferably formed from an electrical insulating material such as plastic or Teflon. The insulator 220 includes a forward portion 221 including a forward internal bore adapted to receive the center pin 210. The insulator 220 also includes a rear portion 223 including a rear internal bore 224 adapted to receive the retainer ring 215. The rear portion 223 may also include an outer shoulder 222 for receiving the printed circuit board assembly 230.

The networked connector 200 also includes a center guide insulator 240, preferably formed from an electrical insulating material such as plastic or Teflon. The center guide insulator 240 includes a forward portion 241 that has a forward internal bore 242 adapted to receive the rear portion 213 of the center pin 210. The center guide insulator 240 also has a rear portion 243 that includes a pass-through bore 244 adapted to allow the center conductor of a coaxial cable to pass through to the inner bore 214 of the center pin 210.

The networked connector 200 also includes a core funnel 250, preferably formed from a conductive material as is known in the art. The core funnel 250 includes a forward portion 251 and a rear portion 256. The forward portion 251 includes a front opening 257 defined in the forward surface of the forward portion 251. The front opening 257 reveals a forward inner bore 253. The forward inner bore 253 is adapted to receive the center guide insulator 240, such that when inserted, the center guide insulator 240 is flush with the forward surface of the forward portion 251 of the core funnel 250. The forward portion 251 may also include a shoulder portion 252 for abutting against the printed circuit board assembly 230.

The core funnel 250 also includes a rear portion 256 that includes a rear opening 258 to a rear inner bore 254. The opening 258 and rear inner bore 254 are adapted to receive a coaxial cable with the inner insulation that surrounds the center conductor exposed. The rear portion 256 of the core funnel 250 preferably includes a one or more conical step portions 255 for securing the outer braid shield of a coaxial cable around the core funnel 250 and maintaining a proper electrical ground contact.

The networked connector 200 also includes a PCB assembly 230. The PCB assembly 230 is preferably is formed from a printed circuit board material as is known in the art in a disk shape as will be more fully detailed below. The PCB assembly 230 includes a front surface 232 that includes electrical components 231 installed thereon, and a back surface 233. The PCB assembly 230 also includes an opening 234 adapted to fit around the exterior of the center pin 210.

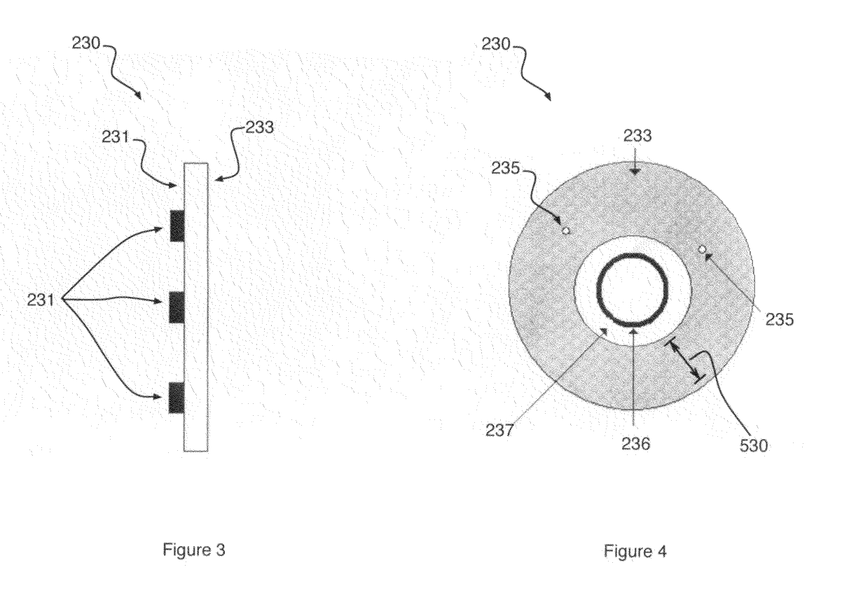

Referring now to FIGS. 3-6, an exemplary embodiment of a PCB assembly 230 and associated circuitry is shown.

FIG. 3 shows a side view of a PCB assembly 230 in accordance with the teachings of this disclosure. FIG. 3 shows the front side 232 and components 231 connected thereon, and the back side 233 of the PCB assembly 230.

FIG. 4 is a view of the back side 233 of the PCB assembly 230. In exemplary embodiments, the back side 233 is adapted to function as the ground or negative connection for the electrical components 231 through a conductive area disposed as an outer radial ground plane 530 proximate to the outer radial area of the disk-shaped printed circuit board. The ground plane 530 may also include pass-through conductive paths 235 for electrically connecting the electrical components 231 on the front side 232 to the ground plane 530.

FIG. 4 also shows an inner positive connection ring 236 for connecting the electrical components 231 to a positive electrical connection. It is contemplated that conductive material is disposed about an inner surface defined by the opening 234 so as to make electrical contact with the center pin 210 when assembled as described more fully below. An insulating area 237 preferably separates the ground plane area 530 and the positive connection ring 236.

Referring now to FIG. 5, an exemplary circuit 500 is shown in schematic form. The circuit 500 includes a positive connection 510 and a negative connection 520. In the schematic of FIG. 5, three circuit branches are shown, each branch comprising a capacitor and resistor in series. A first branch includes a capacitor C1 connected in series with a resistor R1, a second branch includes a capacitor C2 connected in series with a resistor R2, and third branch includes a capacitor C3 connected in series with a resistor R3. The first, second, and third branches are electrically coupled together in parallel between the positive connection 510 and negative or ground connection 520.

It is to be understood that many other circuit topologies are within the scope of the present disclosure, and the disclosed circuit is intended to be illustrative only. It is contemplated that the articulation networks embodiments disclosed herein may be embodied in the networked connector of this disclosure.

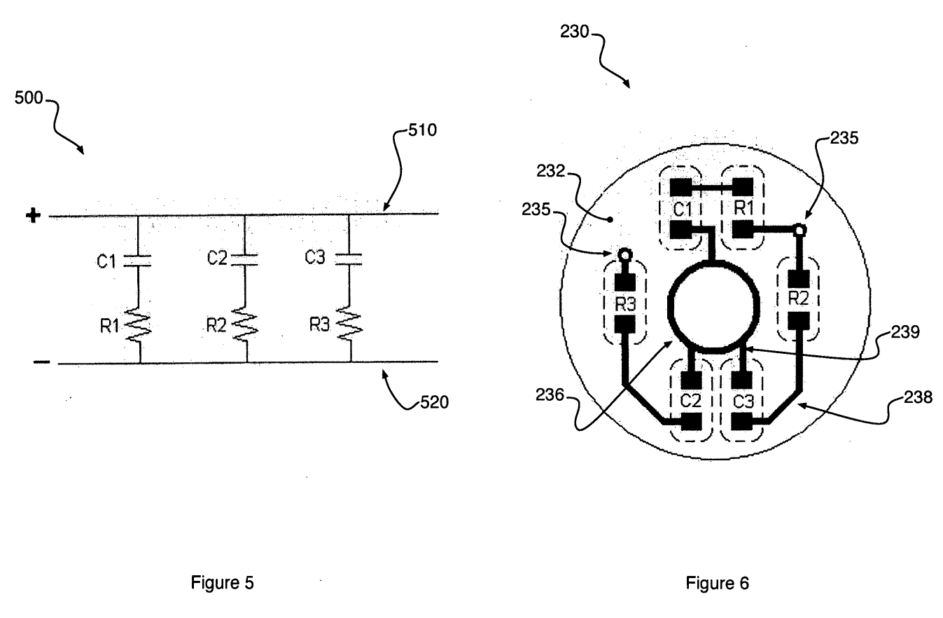

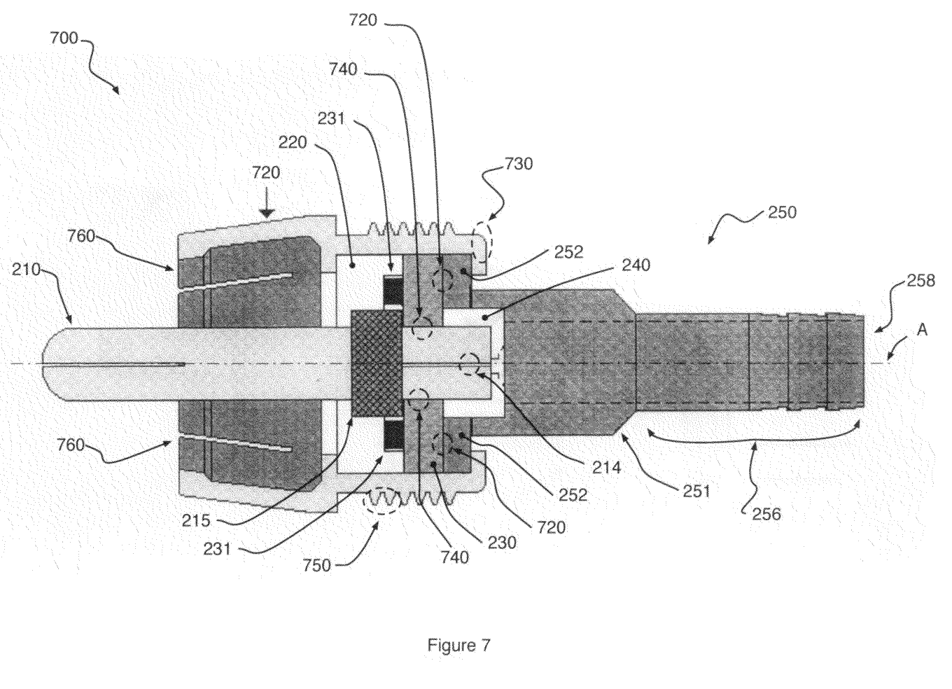

FIG. 6 shows the front surface 235 of the PCB assembly, illustrating how the exemplary circuit 500 may be embodied in accordance with the teachings of this disclosure. For illustrative purposes, the connection of the capacitor C3 and resistor R3 will be shown; the other branches of the circuit 500 are connected in a similar manner.

In FIG. 6, the capacitors and resistors may comprise surface mount components formed as is known in the art on the front surface 232 of the PCB assembly 230. It is contemplated that any electrical component suitable in size to be installed within the desired connector assembly may be employed herein.

Capacitor C3 is show being connected between to the positive connection through the positive center ring 236 at node 239, and to resistor R3 via a conductive path 238, which may be formed on the front surface 232. Resistor R3 is shown being connected to C3 through path 238 and to the ground plane 530 on the back side 233 through pass-through connector 235.

As will now be appreciated from the topology of FIG. 6, all branches of the circuit 500 are connected to a common positive connection via the inner positive connection ring 236, and the negative or ground connections are accomplished via the pass-through connections to the ground plane 530 on the back side 233 of the PCB assembly 230 to form a common ground.

Referring now to FIG. 7, a cross-sectional assembly diagram of networked connector 700 is shown. FIG. 7 shows the networked connector of FIGS. 2-6 assembled along the axis A and affixed together using an RCA connector head 710. The RCA head 710 includes flanges 760 for making the electrical ground connection to a female RCA connector to which the networked connector 700 is attached, and threads 750 for receiving an RCA body portion (not shown).

To assemble the networked connector, the following process may be employed, beginning with the center pin 210.

Center pin 210 is inserted through the rear portion 223 of the insulator 220, until the retainer ring 215 is firmly seated within the rear inner bore 224. The PCB assembly 230 may be slid over the rear portion 213 of the center pin 210. When seated, the inner positive connection ring 236 is brought into electrical contact with the outer surface of the center pin 210 at areas 740, forming a positive connection for the circuit components 231.

The center guide insulator 240 is then placed on the rear portion 213 of the center pin 210, and the cone funnel 250 is placed over the center guide insulator 240. The forward portion 251 of the cone funnel 250 is then brought into contact with the back surface 233 of PCB assembly 230. The ground plane 530 is therefore brought into electrical contact with the shoulder portion 252 and thus the cone funnel 250.

To secure the various parts of the networked connector 700 together, the RCA head 710 may have a portion crimped over the shoulder portion 252 to form a crimp connection 730. The compressive action of the crimp 730 forces the PCB assembly 230 against the retainer ring 215, and the shoulder portion 252 against the ground plane 530 on the back side 233 of the PCB assembly 230. In such a manner, the electrical connection through the circuitry 231 is maintained in an effective fashion.

When installed on the end of a cable, the center conductor of the cable will be inserted through the opening 258 and into the inner bore 214 of the center pin 210. The ground conductor, typically the braid shield of the cable, will be connected to the rear portion 256 of the cone funnel 250. Thus, the circuitry 231 will be electrically coupled between the center conductor and ground connection of the cable through the center pin 210 and cone funnel 250, respectively.

It will be appreciated by those of ordinary skill in the art that the invention can be embodied in other specific forms without departing from the spirit or essential character thereof. The foregoing description is therefore considered in all respects to be illustrative and not restrictive. The scope of the invention is indicated by the appended claims, and all changes which come within the meaning and range of equivalents thereof are intended to be embraced therein.

I claim:

1. A ganged articulation network comprising:
a plurality of articulation networks electrically coupled in parallel to an electrical conductor, the electrical conductor having an natural articulation frequency;
each of said plurality of articulation networks having a predetermined articulation characteristic; and
wherein the articulation characteristics of said plurality of articulation networks maintain a constant articulation in relation to said natural articulation frequency of said electrical conductor.
